(19) United States
(12) Patent Application Publication
(10) Pub. No.: US 2021/0233022 A1
(43) Pub. Date: Jul. 29, 2021

(54) Keep it moving safety 7 compliance app

(71) Applicant: Kimberly Lynn Price, Dyer, IN (US)

(72) Inventor: Kimberly Lynn Price, Dyer, IN (US)

(21) Appl. No.: 16/501,483

(22) Filed: Jan. 27, 2020

(51) Int. Cl. G06Q 10/08; G06Q 30/00

(52) U.S. Cl. CPC G06Q 10/0838; G06Q 30/018; G06Q 10/0833

(57) ABSTRACT

A System Built For Monitoring Trucks and Drivers

### SPECIFICATION TECHNICAL FIELD OF THE INVENTION

This disclosure relates to techniques for transportation management, and, but without limitation, techniques for shipping and fleet management. Background of the invention Highways and roads are the backbone of the transportation system of most developed or developing countries. While other modes of transportation, such as aircraft, trains, and marine vessels may be used, highways and roads are generally pervasive and available to all citizens for use. As a result of the large network of highways and the locations that are reachable using them, trucking is one of the most often-used modes of transportation for shipping goods, materials for goods, etc. Fleet vehicle operators have an interest in keeping track of the vehicles and shipments, for compliance with governmental regulations as well as monitor the performance and wellbeing of their drivers. Fleet vehicles may be equipped with devices that are configured to track the vehicles' geographic locations, speeds, headings, cargo, cargo temperature, engine performance parameters, and other data. Such information is used, for example, to maintain the vehicles, estimate delivery times, provide warning of possible damage to cargo, and to evaluate driver performance. Collection of fleet vehicle information may also be useful to produce records for compliance with governmental regulations or company requirements. As examples, such records may include the number of miles a delivery vehicle has travelled since its last safety inspection and the number of hours a driver has been on duty since he or she last rested. This information was traditionally recorded on paper, e.g., driver logbooks, or in proprietary electronic formats. In either case, ensuring compliance with governmental regulations or company requirements may be time consuming and such information may be inconvenient to access or share with regulatory inspectors or other third parties. One of the largest government-mandated paperwork and cost burdens imposed upon any segment of private industry are the reporting requirements relating to commercial motor vehicles (CMV). Commercial Motor Vehicles (CMV) and their respective drivers and carriers are required by various federal regulations and international agreements to comply with rules 2 governing the safe operation of the vehicles and the reporting of fuel taxes. In 1937, the federal government-imposed hours of-service (HOS) regulations upon commercial motor vehicle drivers operating commercial vehicles in the domestic motor carrier industry to ensure highway safety. Under direction of Congress, the Federal Motor Carrier Safety Administration (FMCSA) has scrutinized and periodically revised the hours-of-service regulations to aid in the reduction of driver fatigue and steep disorder related incidents on the nation's highways. Federal regulations relating to the safe operation of Commercial Motor Vehicles (CMV) are defined in 49 CFR Part 395 and 49 CFR Part 390.2&.15, the entirety of each of which are incorporated by reference. One way in which safety is promoted in the hours-of service regulations is to prohibit drivers from operating or being forced to operate their vehicles more than a specified amount of time between mandatory off-duty periods. In 1987, the FMCSA permitted carriers the flexibility of using an automatic on-board recording device (AOBRD) instead of the traditional reporting method involving manual data entry and filing of reports by the CMV drivers and/or their carriers. The International Fuel Tax Agreement (IFTA) is an agreement among jurisdictions in the United States, Mexico and Canada that simplifies the reporting of fuel-use tax for diesel, gasoline, gasohol, propane, and natural gas consumption by commercial motor vehicles. Fuel use tax is included in the purchase price of the fuel and then later redistributed to those jurisdictions where the vehicle was driven while consuming fuel. For example, a driver Of a CMV may purchase diesel fuel in the state of Texas and travel outside of Texas to a neighboring state, e.g., Louisiana, using the same diesel fuel purchased in Texas. IFTA requires 3 carriers to report actual mileage driven in each jurisdiction so that the actual taxes collected may be later apportioned to Texas and Louisiana in accordance with actual vehicle operation. Each day, some 6.4 million drivers complete HOS logs to track driver compliance with HOS regulations. In addition, fuel tax logs are created daily for some 10 million trucks. The cost of compliance with these reporting requirements is extraordinarily burdensome. It is estimated that the annual cost of complying with reporting requirements using paper logs is approximately $2,000.00 per driver and $2,000.00 per commercial motor vehicle. This results in a paper log compliance cost of $31 billion dollars per year imposed upon private industry. Transportation companies spend an average of $ 15,000 dollars a year with driver turnover. Between the driver screening, corporate fillings, service background checks, MVR Monitoring/Live, and the like, these companies spend an inordinate amount of time and money on such mundane occurrences as these. Something as simple as a child support payment revokes a driver's cdl. If a driver gets pulled over for any reason, then it is a ding on the company for being incompetent and could result in a $5000 fine. Drug and Alcohol programs Fmcsa demand that the owners of companies to be accountable for every move. The brokers want to be able to track certain shipments for the customers. If a company is audited, owners end up paying around an average of $9000 which is about $180 an hour for a person to represent them and complete the audit. The aftermath after is even higher to fix. The company will be required to hire a safety compliance company to monitor everything and fix issues. Every time a driver starts a new job they have to go through the same thing over and over. 90% of the time, the driver does not remember start and finish dates and hiring company contacts for new employer. Or, if they get in trouble no matter what state, they must find a lawyer to help them Therefore, there is a need for a means to track and record shipments as well as driver profiles. It is an object of the present invention to provide such as system.

### SUMMARY OF THE INVENTION

The system embodying the present invention is created is around the driver with a

Company regulation in mind for a company to be audited. Monitoring companies require recording

accidents and instructions regarding further actions. These actions are taken during real time so the information is available to the company so they will be able to answer questions so later there is no mistaken about what has happened The invention is embodied in an app which performs the required functions when activated.

### BRIEF DESCRIPTION OF THE DRAWING FIGURES

FIG. 1 shows an overview of the system embodying the present invention.

### DETAILED DESCRIPTION OF THE PREFERRED EMBODIMENT OF THE INVENTION

Other objects, features and advantages of the invention will become apparent from a consideration of the following detailed description and the accompanying drawings.

The present invention is embodied in the following modules and is activated by means of Screens
1. Splash Screen with logo
2. Sign up
3. Sign in
4. Forgot Password
5. OTP
6. Rest password
7. 8,9.Home. main menu for uploads
10 Conformation Screen
11 Contact us
12 Slide left for side menu DRIVER BRIEF CASE:

49 CFR 391.25 (a) and (c)Review of Driving Record—Annual—49 CFR 391.25 (c) (2)Driver's Certification of Violations—Annual—49 CFR 39127Medical Examination Report and Medical

Examiner's Certificate—49 CFR 391.43Employer note verifying that medical examiner is listed

on National Registry of Certified Medical Examiners—Non-COL drivers: 49 CFR 391 ,51 CDL drivers: 49 CFR 391.51 Application for Employment—49 CFR 39L21.

Safely Performance History Records: Driver Correction or Rebuttal (if applicable)—49 CFR and 49 CFR

Inquiry To State Agencies for 3-Year Driving Record—49 CFR 391.23(a)(1)and(b) Preemployment Drug and Alcohol Documents—49 CFR 40.25(0·, 49 CFR 382.301

Multiple Employer Drivers—49 CFR 391.63

### Uploads

A Driver Application electronic APP

Every time a driver goes to a company, he can update information that can be put into a cloud

downloadable to a cloud account this will make all information up to date This application would

include a copy of MVR Med Card, CDL

### Emergency Contact Information

Point of contact information. Doctor Information

Med information

### Violation Ticket Category.

Anytime driver gets a Violation ticket warning he just must take a picture of it and download into his Cloud

### Inspections

All inspections can be put into file with bad inspections with maintenance errors will have the

receipt with the inspection as well as 10 for that day (4396.11, 396.13, and 396.17 are in addition to the systematic inspection, repair, and maintenance required by 6396.3).

### Accident Register

All the information will be able to be put into his system

This keeps the driver up to date on his losses and is easily obtainable for insurance companies

to assist in getting them approved for new company hires

Owner Operators and drivers have a place to upload all their maintenance files and receipts ELD

Built in for previous work so they do not have to keep learning different systems, adding different

apps different sign ins and the last i4 days are already logged so when auditor comes in there are

no questions about the accuracy of hours

Company sign on and sign offs on employment Insurance on file

### (Owner Operators)

Place for them to have their filling on file

2290 ,ucr, insurance—no more having to call a hundred different people to obtain the information saves time and money. Point of contact Information: Doctor Information: Medical information

It is understood that while certain forms of the present invention have been illustrated and described herein, it is not to be limited to the specific forms or arrangements of parts

### The Software is Compatible to ISO and Android

Company Side/owner operator DOT Regulations Maintain audit Desktop Windows Client
1.4 GHz Intel© Pentium© 4 or faster processor (or equivalent) for Microsoft© Windows© XP or Windows 7; 2 GHz Pentium 4 or faster processor (or equivalent) for Windows Vista©
Windows XP, Windows Vista, Windows 7, Windows 8, or Windows 10
1 GB of RAM (2 GB recommended) for Windows XP; 2 GB of RAM (4 GB recommended) for Windows 7/Vista, Windows 8 or Windows 10.
50 MB of hard drive space Windows Server
2 GHz Intel© Pentium© 4 or faster processor (or equivalent)
Windows XP, Windows Vista, Windows 7, Windows 8, Windows 10. Windows 2003, or Windows Server 2008-2016
2 GB of RAM (4 GB recommended)

### Safety Management Cycle for the Vehicle

### Maintenance BASIC—Inspection-Repair-Maintenance

### 5.2.1 Records

Records of all inspections, repairs, and maintenance must be retained. According to 49 CFR 396.3, required records include the following:
Identifying information of the vehicle, including company number, make, serial number, year, and tire size; (See also, Marking of Self-Propelled CMVs and Intermodal Equipment.)
A schedule highlighting the type and due date of inspections and maintenance to be performed; and Inspection, repair, and maintenance records indicating the date and nature of each. Inspection, repair, and maintenance records indicating the date and nature of each.

Carriers must maintain records for each vehicle they control through ownership or lease for 30 consecutive days. These records must be retained for one year at the location where the vehicle is housed or maintained. These records must be retained for six months after the vehicle leaves the carrier's control (sale, trade-in, etc.).

Passenger carriers must keep records of tests conducted on emergency doors, emergency door marking lights, and pushout windows,

The SMC is used to systematically assess SMPs in six areas:
1. Policies and Procedures, 2. Roles and Responsibilities, 3. Qualification and Hiring, 4. Training and Communication, 5. Monitoring and Tracking, and 6. Meaningful Action. By periodically reviewing each process, there is an opportunity to identify and correct breakdowns in SMPs before safety and compliance issues are identified, or crashes occur. The SMC can also be used after safety and compliance issues or crashes have taken place to assist in determining which SMPs need attention.
   The SMCs for each BASIC can be found in the Information Center on the SMS Website at http://ai.fmcsa.dot.gov/sms

### Policies and Procedures

Develop a system of preventive maintenance for compliant, safe, and efficient fleet operations, including a schedule

for periodic maintenance, inspection, and recordkeeping. This system should be attuned to manufacturer recommendations, the carrier's own experience, and regulatory requirements.
Develop a procedure ensuring that vehicle defects that impact safety and/or safety compliance are reported, repaired, and certified before the vehicle is operated.
Develop procedures to ensure that management is notified of vehicle defects using Driver Vehicle Inspection

Records (DVIRS) and other communication channels, such as driver call-in and e-mail from mechanics.
Develop a policy ensuring that drivers are qualified to complete thorough and timely DVIRs by the end of the day of the trip and prior to a subsequent assignment.
Establish a policy requiring drivers to submit copies of all roadside inspections to carrier management within 24 hours.
Develop policies and procedures requiring drivers to immediately notify appropriate management of any roadside vehicle Out-of-Service Order (OOSO).
Develop a written and progressive disciplinary policy focused on taking corrective action to ensure drivers comply with

regulations and policies. A progressive disciplinary policy could include, among other things, written warnings, suspensions, or work restrictions, monetary penalties, and termination. This policy should also specify consequences for any carrier official who knowingly and willfully allows maintenance violations. Passenger Carrier Only:
Develop systematic procedures for inspecting maintenance items critical to fire safety and emergency evacuation—for

example, checking wheel-hub lubrication levels according to the manufacturer's recommended inspection intervals,

checking wheels for signs of excess heat every time the motor coach is parked, regularly inspecting wiring and electrical systems for short circuits and inspecting emergency exit operation and markings.
Consider installation of fire detection and suppression systems on current fleets and as purchase options on new coaches.

### Roles and Responsibilities

Define and document responsibilities of managers, supervisors, drivers, dispatchers, mechanics, and technicians as

related to vehicle inspection, repair, and maintenance policies, including the monitoring and documentation of defects and repairs.
Define and document roles and responsibilities of mechanics and technicians for differentiating between safety-related defects and other defects and for taking unsafe vehicles out-of-service (OOS).
Empower the person who oversees fixing trucks with the authority to complete tasks, such as the purchasing of new parts when needed.
Define and document roles and responsibilities for checking daily completion of DVIRs and certifying repair before the next assignment.
Define and document dispatcher responsibilities for planning, scheduling, monitoring, and adjusting fleet operations in accordance with repair and maintenance requirements.
Define driver responsibilities for informing managers, supervisors, and mechanics/technicians of safety-related defects

and repair requirements prior to vehicle operation, including those resulting from vehicle OOSOs.

### Passenger Carrier Only:

Designate a manager to collect and evaluate all vehicle inspection-, repair-, and maintenance-related customer complaints and their safety implications.

### Qualification and Hiring

Ensure that prospective employees are qualified to inspect, repair, and maintain the carrier's vehicles by querying

applicants, checking with previous employers and references, and obtaining necessary documents regarding

inspection, repair, and maintenance responsibilities and (for mechanics and technicians) the quality of previous work, including whether maintenance services were systematic and well documented. Create a detailed written record of each inquiry.
Query the FMCSA information systems to check the vehicle inspection, repair, and maintenance performance (violations, OOS rates, etc.) of other carriers for whom the mechanic has worked. Then, ask follow-up questions to better determine the mechanics performance in those previous jobs.

### U.S. Department of Transportation

Federal Motor Carrier Safety Administration

HTTP://CSA.FMCSA.DOT.GOV|JANUARY 2013 3 FMC-CSA-13-005

Safety Management Cycle for the Vehicle Maintenance BASIC—Inspection-Repair-Maintenance
Verify prospective brake inspectors' understanding of job requirements and their applicable training and apprenticeship credentials.
Screen prospective dispatchers for flexibility and the ability to deal with crisis by posing “what if” scenarios, such

as how they would expedite an emergency repair or a replacement vehicle if given an OOS call on a critical haul.
Assess prospective drivers' understanding of their responsibility for, and experience with, inspecting and maintaining the vehicle, reporting defects, and verifying repairs.
Ensure that the employment application captures all information required by Federal Motor Carrier Safety Regulations

(FMCSRs)—for example, for drivers, about types of vehicles operated, and for mechanics and technicians, with regard to certification of the ability to perform repairs.
Enhance the recruitment process to identify and attract qualified applicants for the positions of safety director,

mechanic, and other roles with responsibility for inspection, repair, and maintenance, using outside resources such

as insurance companies, industry groups, and consultants for employee searches and referrals.

### Passenger Carrier Only:

Verify that mechanics and technicians are familiar with advanced technology and are certified for the vehicles on which they will be working.

### Training and Communication

Convey expectations to all applicable staff for adhering to vehicle inspection, repairing, and maintenance regulations

and company policies and procedures, and for executing responsibilities by providing new hire and refresher training,

and establish communication channels such as newsletters and/or meetings focused on conflicts between vehicle availability and repair requirements.
Ensure that all employees understand and accept their responsibility for timely communication of safety issues related to fleet inspection, repair, and maintenance to the appropriate individuals.
Ensure that managers and supervisors articulate their commitment to and establish communication with employees concerning vehicle inspection, repair, and maintenance.
Communicate the carrier's Vehicle Maintenance BASIC percentile to all staff and explain to them individually what they can do to help improve compliance.
Ensure that mechanics and technicians communicate with the vehicle and equipment manufacturers and receive regular updated bulletins and recommendations.

Ensure that carriers with non-English-speaking employees who need to communicate with English-speaking employees

and to understand English language literature, such as the manufacturer's guide, have ways to deal successfully with language barriers.
Ensure that all drivers, dispatchers, managers, mechanics, and technicians receive training, including methods and

tools, and appropriate certifications to fulfill their responsibilities and documentation requirements regarding vehicle inspection, repair, and maintenance, as required by regulations and company policies.
Implement and provide training for a fleet maintenance software system that can be updated according to current

industry and regulatory standards, manufacturer's recommendations, and the carrier's experience.
Train mechanics to be able to differentiate between safety-related defects and other defects—for example, by

recognizing that defective wheel ends can lead to wheel separation.

### U.S. Department of Transportation

Federal Motor Carrier Safety Administration

HTTP://CSA.FMCSA.DOT.GOV|JANUARY 2013 4 FMC-CSA-13-005

Safety Management Cycle for the Vehicle Maintenance BASIC—Inspection RepairMaintenance
Ensure that drivers are trained in vehicle OOS rules, their responsibilities in adhering to them, and the carrier's

procedures for reporting OOS violations and communicating appropriately with other personnel.
Train all staff who are required to monitor and track vehicle maintenance on the appropriate company policies, including those related to discipline and incentives.
Provide hiring officials with guidance on how best to attract, screen, and qualify applicants who are most likely to

adhere to vehicle inspection, repairing, and maintenance regulations and company policies and procedures.
Reinforce training to drivers, mechanics, and other employees about vehicle maintenance policies, procedures, and

responsibilities, using job aids, post-training testing, and/or refresher training. Encourage informal feedback among drivers and mechanics so that they can help each other to improve.

### Passenger Carrier Only:

Provide training on procedures related to fire safety and emergency evacuation, such as checking wheel-hub lubrication

levels according to the manufacturer's recommended inspection intervals, checking wheels for signs of excess heat

every time the motorcoach is parked, regularly inspecting wiring and electrical systems for short circuits, and inspecting emergency exit operation and markings.

### Monitoring and Tracking

Check all inspections and relevant records, such as DVIRs, pre-trip and annual inspections, and maintenance and

repair records, to ensure that company inspection, repairing, and maintenance policies and procedures are adhered to and properly documented.
Ensure that DVIRs are effectively coordinated with maintenance and operations, result in timely corrective measures, and are verified during pre-trip inspections as applicable.
Require mechanics to note whether parts came from inventory or were ordered, to ensure accuracy of maintenance records.
Monitor and track roadside inspection results to ensure that vehicle defects are repaired and documented promptly and to prevent OOS vehicles from operating prior to being repaired.
Monitor manufacturer recalls through www.nhtsa.dot.gov and consult with manufacturer service representatives to keep current with service bulletins for proactive maintenance.
Implement a system for keeping accurate records of employee inspection, repair, and maintenance training needs,

including updates on a carrier's fleet or equipment and completed training, via software, a checklist in the driver's file, and/or another appropriate method.
Regularly evaluate the company's vehicle-maintenance-related inspection results via FMCSA's Website at

http://ai.fmcsa.dot.gov/SMS. Assess violations for process breakdowns and how to remedy them.
Maintain inspection, repair, maintenance, vehicle identification, and communication records to help evaluate the

performance of all staff (drivers, dispatchers, mechanics, and managers) involved in fleet maintenance and the

effectiveness of compliance with vehicle maintenance policies, procedures, and regulations.
Evaluate personnel who are monitoring vehicle maintenance performance by making sure they are using DVIRS,

roadside inspections, and other data; applying performance standards fairly, consistently, and equitably; and documenting evaluations.
When monitoring and tracking vehicle maintenance issues, always assess whether an issue is individual or

represents a systemic breakdown in one of the SMPs (Policies and Procedures, Roles and Responsibilities, etc.).

### U.S. Department of Transportation

### Federal Motor Carrier Safety Administration

HTTP://CSA.FMCSA.DOT.GOV|JANUARY 2013 5 FMC-CSA-13-005

Safety Management Cycle for the Vehicle Maintenance BASIC—Inspection RepairMaintenance

### Passenger Carrier Only:

Monitor manufacturer recalls through www.nhtsa.dot.gov;
consult with manufacturer service representatives to keep current with service bulletins for proactive maintenance, especially with regard to preowned buses.
Monitor and track vehicle-maintenance-related passenger complaints and assess safety implications.

### Meaningful Action

Design and implement incentives and/or recognition programs in order to reward and encourage effective performance

related to compliance with vehicle inspection, repair, and maintenance regulations and company policies—for example,

to include bonuses, gift certificates, and/or verbal recognition to drivers for a clean Level 1 inspection report.
Give employees immediate feedback, and require corrective action as soon as the company is aware that vehicle inspection, repair, and maintenance responsibilities are not being fulfilled.
Provide remedial training to employees with performance issues related to vehicle inspection, repair, and maintenance that can be addressed by enhancing their knowledge and skills.
Implement a disciplinary policy where potential disciplinary measures correspond to risk posed, with violations associated with high-consequence accidents or incidents being punished more severely.
Discipline carrier officials for knowingly and willfully allowing violations of vehicle inspection-, repair-, and maintenancerelated regulations, such as allowing a driver to use a truck that is in disrepair.
If the problem related to vehicle maintenance is systemic, make adjustments to one or more of the SMPs (Policies and Procedures, Roles and Responsibilities, etc.).

### Driver-Related Documents

1. Drivers List
2. Driver's License
3. Driver's Records of Duty (ROD) and Supporting Documentation
4. Driver's Motor Vehicle Record (MVR)
5. Medical Certificate

### Vehicle-Related Documents

1. Vehicle List
2. Vehicle Inspection
3. Hazardous Materials (HM)

### Shipping Papers

### Carrier/Programmatic Related Documents

1. Proof of Insurance
2. Drug & Alcohol Program
3. Accident Register

### Driver

1. Drivers List

All carriers must provide a list of currently employed drivers. This list is used to assess applicability of

various regulations, and should include: each driver's first and last name, date of birth, date of hire, license number, and license State.

### EXAMPLES

Last Name First Name Date of Birth Date of Hire License Number License State

Smith Jane 05/12/1968 02/20/2005 5530-4406-8736 IL

Johnson Wilbur 12/20/1985 07/18/2009 J525-8808-5361 IL Or

Name, Date of Birth, License Number, License State, Date of Hire
Jane Smith, 05/12/1968, S530-4406-8736, IL, 02/20/2005
Wilbur Johnson, 12/20/1985, J525-8808-5361, IL, 07/18/2009

### 2. Driver's License

All commercial motor vehicle (CMV) drivers must be appropriately licensed to drive the specific type

of vehicles they operate. Appropriate licenses are either an Operator's License issued by one State or

jurisdiction, a Commercial Driver's License (CDL) (with proper endorsements as necessary), a Canadian

License or a Licensees Federales de Conductor issued by the Mexican Government. In order to obtain any of these licenses, drivers must have passed a knowledge and skills test for the appropriate type of vehicle.

An Operator's License is required for drivers of CMVs that:
Have a gross vehicle weight rating (GVWR) or gross combination weight rating (GCWR) of 10,000-26,000 lbs (including towing vehicle)
Transport 8-15 passengers (including the driver) for compensation (for-hire) (See FMCSR General Regulation Definitions and Guidance for more information) Exceptions
Farm vehicles and their drivers when the vehicle is:
Controlled and operated by a farmer as a private motor carrier of property
Being used to transport either agricultural products or farm machinery and/or supplies to or from a farm
Not being used in the operation of a for-hire carrier
Not carrying placard able HM
Being used within 150 air miles of the farm
Vehicle controlled by a beekeeper engaged in seasonal transportation of bees
School buses, Federal/State operations, property moved not for commerce, carrying corpses,

ambulances, fire trucks responding to an emergency, 9-15 passengers private vehicles, propane, winter heating fuel

A CDL is required for drivers of CMVs that:
Have a GVWR or GCWR of 26,001 lbs or more (including towed trailers/vehicles)
Transport 16 or more passengers (including the driver) either for compensation (forhire) or not for compensation (private)
Transport placard able amounts of Hazardous Materials (see 49 CFR Part 172 Subpart F)

(See FMCSR General Regulation Definitions and Guidance for CDL for more information) In addition, drivers of certain vehicles requiring a CDL must pass additional tests to obtain an appropriate endorsement as explained on FMCSA's Commercial Driver's License web page.

### Exceptions

Military drivers operating a CMV for military purposes
Farm vehicle drivers where the vehicle is:
Controlled and operated by a farmer as a private motor carrier of property
Being used to transport either agricultural products or farm machinery and/or supplies to or from a farm
Not being used in the operation of a for-hire carrier
Not carrying placardable HM
Being used within 150 air miles of the farm
Firefighters, emergency response vehicle drivers, and drivers removing snow and ice Laws/Regulations
Federal Motor Carrier Safety Regulation Part 383, Commercial Driver's License Standards.

### Requirements and Penalties

Federal Motor Carrier Safety Regulation Part 391 Subpart B (391.11-391.15), Qualifications and

### Disqualifications of Drivers

### Additional Resources

Commercial Driver's License Program (CDL/CDLIS)

### 3. Driver's Records of Duty (ROD) & Supporting Documentation

Every motor carrier must require every driver to record his/her duty status for each 24 hour period using specific methods outlined by regulation. Logs/Records of Duty Status (RODs) must be kept

current by showing each change in duty status. The time zone used on a driver's daily log should be

the time standard of that driver's home terminal. For each change in duty status, the name of the

city/town/village with the State abbreviations must be recorded. In addition to the status of the

driver, specific information must be included as outlined in 395.8. During a Safety Audit, motor

carriers may be asked to submit documents supporting the driver's record of duty. Such documents

can include any of the following: toll receipts/records, fuel receipts/records, bills of lading, trip reports or another type of document for verification.

This system has all sides in Mind
1. Lawyer Outreach

company or driver they have number to call whatever their needs may be so they can keep it moving
2. able to file 2290s/ucr/renewals/ifta/ at the push of a button
3. accounting services platform for driver or owner operator no more taking time off to do it
4. insurance quotes platform information is already in their system
5. data q sign in and dispute
6. ROADSIDE

### DISPATCHERS WILL NO LONGER HAVE TO LOOK UP AND MAKE CALLS THEY ONLY HAVE TO APPROVE

### Search Results

Safety Audit Resource Guide—US Department of Transportation

Different Types of Audits incurred for the information Sample Per Regulation Types of DOT Audits & Required Documentation

Compliance Review Security Hazardous Materials New Entrant, Shipping Documents, Driver Qualifications, Hours of Serviced & Maintenance,Accident,Placarding

HazMat Registration, Drug Testing Program, Security Plan, Financial Plan

### Operations Review

1—Full audit verifying historical, current and systematic compliance.
2—Small sample to demonstrate understanding of compliance.

Vehicle Maintenance files showing vehicle identification, maintenance schedule and photos,

Unit Number, tire size, Vin Number, Make, Model and Year

Vehicle Annual Inspections—14 months or 2 reports from last inspection

Cargo tank records including manufacturer's certificate of origin (“birth certificate”), tank test

and inspection paperwork

Hazmat driver training records and program

USDOT Hazmat Registration (http://hazmat.dot.gov/regs/register/register.htm) Driver's log or time sheets for the 100 mile exemption Paperwork for annual vehicle inspections.

Keep duplicates of everything required to be in vehicle in the office!

Accident Register—maintain for at least 3 years from date of accident

Hazmat Companies Information (if applicable). Make sure all certifications and recertifications are current.

### Federal Hazardous Registration

HM-126 Training test and certificate (driver's and office personnel) every 2 years

HM-232 Driver security training and certificate and re-certification every 2 years

Vehicle—Visual, Annual Tank Test Records

Quarterly Drug and Alcohol Consortium Test Results Propane Companies—All Hazmat Information Plus:

### HM225A Training for Each Driver

Monthly hose inspections (minimum 12 months)

Vehicle—visual, annual tank test records

Unique hose identification numbers on all hoses

Remote shut off testing at 150 feet away every morning

DOT certificate of compliance for each bobtail and pipe drawing

### Inside Vehicle

Proper Shipping papers with emergency response information

Emergency response telephone number Hazmat registration

Driver's daily vehicle inspection report (DVIR)

Driver's daily log book (DDL) or eLog access

### Vehicle Registration & Proof of Insurance

Proof of For-Hire authority, if applicable

It is very important that each person in the company adhere to the guidelines, rules and regulations as set forth by FMCSA and DOT. Continuing the effort to remain compliant will go a longway when a DOT safety audit is encountered. The greater the preparation, the more likely your company is to pass an audit. It's much better to take the time to ensure your documentation is complete and up to date before you are caught off guard. The fines that DOT are now able to impose are much greater and not worth it! Properly training each member of your organization will help everyone stay on top of compliance.

### Cloud Services—Hosting Solution

Internet Services experience may vary. Recommended for High speed Internet use only. Cloud access is supported by most Microsoft remote desktop application clients. May be subject to Microsoft, Android, or Apple app-store availability.

We recommend a minimum resolution of 1) 1280×768 on RDP Portal or 2) 1440×900 on web browser portal. (web access)

Web Browser with HTML 5 support is required for web access.

### Desktop Windows Client

1.4 GHz Intel© Pentium© 4 or faster processor (or equivalent) for Microsoft© Windows© XP or Windows 7; 2 GHz Pentium 4 or faster processor (or equivalent) for Windows Vista©
Windows XP, Windows Vista, Windows 7, Windows 8, or Windows 10
1 GB of RAM (2 GB recommended) for Windows XP; 2 GB of RAM (4 GB recommended) for Windows 7/Vista, Windows 8 or Windows 10.
50 MB of hard drive space

### Windows Server

2 GHz Intel© Pentium© 4 or faster processor (or equivalent)
Windows XP, Windows Vista, Windows 7, Windows 8, Windows 10. Windows 2003, or Windows Server 2008-2016
2 GB of RAM (4 GB recommended)
50 MB of hard drive space for the install and 200+MB for database.

### Network

100 Mbps or higher Wired Ethernet Network

### Remote/Work From Home

Remoting can be provisioned with Citrix© or Terminal Services provisioned by

### Microsoft Windows Server

Be advised that some wireless connections do not meet the minimums required to be a true Broadband connection. Wireless results may vary.

The following are the specs are recommended for optimum server performance. These are well above our minimum specs.

### Recommended Specs

Processor: INTEL CORE i7 (Quad Core) or Xeon

Hard drive: 2 Total =1 SSD (for Operation) plus 1TB. (for Storage) Operating System: Windows 10 or Windows Server 2016 RAM Memory:

8-16 GB.

LAN: Gigabit Wired Connection.

### Cloud Services—Hosting Solution

Internet Services experience may vary. Recommended for High speed Internet use only.

Cloud access is supported by most Microsoft remote desktop application clients. May be subject to Microsoft, Android, or Apple app-store availability.

We recommend a minimum resolution of 1) 1280×768 on RDP Portal or 2) 1440×900 on web browser portal. (webaccess)

Web Browser with HTML 5 support is required for webaccess.

### Desktop Windows Client

1.4 GHz Intel© Pentium© 4 or faster processor (or equivalent) for Microsoft© Windows© XP or Windows 7; 2GHz Pentium 4 or faster processor (or equivalent) for Windows Vista©
Windows XP, Windows Vista, Windows 7, Windows 8, or Windows 10
1 GB of RAM (2 GB recommended) for Windows XP; 2 GB of RAM (4 GB recommended) for Windows 7/Vista, Windows 8 or Windows 10.
50 MB of hard drive space

### Windows Server

2 GHz Intel© Pentium© 4 or faster processor (or equivalent)
Windows XP, Windows Vista, Windows 7, Windows 8, Windows 10. Windows 2003, or Windows Server 2008-2016
2 GB of RAM (4 GB recommended)
50 MB of hard drive space for the install and 200+MB for database.

### Network

100 Mbps or higher Wired Ethernet Network

### Remote/Work From Home

Remoting can be provisioned with Citrix© or Terminal Services provisioned by Microsoft Windows Server

Be advised that some wireless connections do not meet the minimums required to be a true Broadband connection. Wireless results may vary.

The following are the specs are recommended for optimum server performance. These are well above our minimum specs.

### Recommended Specs

Processor: INTEL CORE i7 (Quad Core) or Xeon

Hard drive: 2 Total =1 SSD (for Operation) plus 1TB. (for Storage) Operating System: Windows 10 or Windows Server 2016 RAM Memory: 8-16 GB.

LAN: Gigabit Wired Connection.

It is understood that while certain forms of the present invention have been illustrated and described herein, it is not to be limited to the specific forms or arrangements of parts described and shown.

1. A system for tracking and recording commercial motor vehicle shipments and driver profiles, the system comprising:
a controller;
a vehicle input signal operably connected to the controller, the vehicle input signal indicative of vehicle information;
a driver input signal operably connected to the controller, the driver signal indicative of at least one driver profile,
the controller is programmed to issue a first output signal providing real-time delivery estimations,
the controller is programmed to issue a second output signal indicative of cargo conditions, and
the controller is programmed to issue a third output signal indicative of a state of compliance with Federal regulations,
the controller is programmed to store records of the vehicle input signal, driver input signal, first output signal, second output signal and third output signal, and
the controller is programmed to communicate the driver input signal and the vehicle input signal to a plurality of recipients.

2. The system and apparatus of claim 1, wherein the vehicle input signal further includes a geographic location of the vehicle.

3. The system and apparatus of claim 1, wherein the vehicle input signal further includes a vehicle speed measurement.

4. The system and apparatus of claim 1, wherein the vehicle input signal further includes a vehicle heading.

5. The system and apparatus of claim 1, wherein the vehicle input signal further includes a cargo manifest.

6. The system and apparatus of claim 1, wherein the vehicle input signal further includes a cargo temperature.

7. The system and apparatus of claim 1, wherein the vehicle input signal further includes a series of vehicle performance parameters.

8. The system and apparatus of claim 7, wherein the series of vehicle performance parameters includes fuel levels, oil levels, engine temperature, fuel efficiency, and battery level.

9. The system and apparatus of claim 1, wherein the driver input signal further includes a driver's screening summary.

10. The system and apparatus of claim 1, wherein the driver input signal further includes a series of corporate filings relating to an owner of the vehicle.

11. The system and apparatus of claim 1, wherein the driver input signal further includes a record of driver background checks.

12. The system and apparatus of claim 1, wherein the driver input signal further includes a summary of driver Commercial Driver's License status and standing.

13. The system and apparatus of claim 1, wherein the driver input signal further includes a summary of driving citations and accident reports.

14. The system and apparatus of claim 1, wherein the driver input signal further includes driving logs.

15. The system and apparatus of claim 1, wherein the driver input signal further includes a log of fuel purchases and miles driven in a specific state.

16. The system and apparatus of claim 15, wherein the third output signal includes miles driven in each state, the third output signal configured for transmission to federal agencies to assure fuel tax compliance.

17. The system and apparatus of claim 1, wherein the first output signal includes an evaluation driver performance based on delivery times and driving records.

18. The system and apparatus of claim 1, wherein the vehicle input signal further includes the number of miles the vehicle has travelled since a safety inspection.

19. The system and apparatus of claim 1, wherein the vehicle input signal further includes a time lapsed between rest periods for individual drivers.

20. A method for tracking and recording commercial motor vehicle shipments and driver profiles comprising:
providing a controller;
providing a vehicle input signal operably connected to the controller, the vehicle input signal indicative of vehicle information;
providing a driver input signal operably connected to the controller, the driver signal indicative of at least one driver profile;
wherein the controller is programmed to issue:
a first output signal providing real-time delivery estimations;
a second output signal indicative of cargo conditions; and
a third output signal indicative of a state of compliance with Federal regulations;
wherein the controller is programmed to store records of the vehicle input signal, driver input signal, first output signal, second output signal and third output signal, and the controller programmed to communicate the driver input signal and the vehicle input signal to a plurality of recipients.
